(19) United States
(12) Patent Application Publication
(10) Pub. No.: US 2025/0129106 A1
(43) Pub. Date: Apr. 24, 2025

(54) Use of Chlorine-Free Catalyst in the Preparation of Diisopropylaminosilane

(71) Applicant: Jiangsu Nata Opto-Electronic Material Co., Ltd., Suzhou, Jiangsu (CN)

(72) Inventors: Zheng Lu, Suzhou (CN); Chongxuan Cai, Suzhou (CN); Xiaobing Zhou, Suzhou (CN)

(21) Appl. No.: 18/693,046

(22) PCT Filed: Dec. 16, 2022
(86) PCT No.: PCT/CN2022/139590

§ 371 Date: Mar. 18, 2024

(30) Foreign Application Priority Data
Sep. 26, 2022 (CN) 202211174391.X

(51) Int. Cl. C07F 7/02; B01J 31/16; B01J 37/04

(52) U.S. Cl. CPC C07F 7/025; B01J 31/1608; B01J 37/04; B01J 2523/23; B01J 2523/24; B01J 2523/41

(57) ABSTRACT

The present invention discloses the use of a chlorine-free catalyst in the preparation of diisopropylaminosilane. The chlorine-free catalyst comprises calcium bis(hexamethyldisilazide) and/or strontium bis(hexamethyldisilazide) and diisopropylaminosilane is prepared by a dehydrogenative coupling reaction of monosilane with diisopropylamine catalyzed by a chlorine-free catalyst. The present invention uses a low-cost chlorine-free compound, calcium bis(hexamethyldisilazide) and/or strontium bis(hexamethyldisilazide), as a new catalyst to prepare diisopropylaminosilane, which can effectively catalyze the dehydrogenative coupling reaction of monosilane and diisopropylamine to synthesize diisopropylaminosilane in one step in a yield of 40-65% for diisopropylaminosilane.

### TECHNICAL FIELD

The present invention belongs to the field of organic chemistry and relates to use of a chlorine-free catalyst in the preparation of diisopropylaminosilane, in particular, to use of a chlorine-free catalyst in the preparation of diisopropylaminosilane and to a preparation process for diisopropylaminosilane.

### BACKGROUND ART

Diisopropylaminosilane, as an important silicon-based precursor material, is widely used in vapor deposition and atomic layer deposition techniques to fabricate silicon-based semiconductor thin film materials, such as silicon oxide, silicon nitride, and silicon carbide. These silicon-based semiconductor thin film materials have been used in the fabrication of high-end capacitors, solar cells, memory devices, lasers, light-emitting diodes, gas sensors, and the like.

Aminosilanes can be prepared by conventional chlorosilane amination reactions. JPWO2016152226A1 discloses a method for producing a dialkylaminosilane by a direct reaction of a chlorosilane with a dialkylamine. According to the above patent, a large amount of by-product hydrochlorides is produced in addition to the desired product. This process requires an additional filtration step to obtain the desired product, while a small amount of the hydrochloride salt is dissolved in the product, which requires a later separation, resulting in the product containing a chlorine impurity. In order to improve the problems caused by the use of chlorosilane as the raw material, WO2017106632A1 discloses a method to replace chlorosilane with monosilane as the raw material and directly produces aminosilane through a one-step reaction. There is no solid formation in the obtained product, and the raw materials, monosilane and amine, are both chlorine-free. However, dibutyl magnesium is used as a catalyst in the reaction disclosed in the above-mentioned patent. The catalyst can be obtained by reacting butyl lithium and butyl magnesium chloride as raw materials, or by reacting 1-chlorobutane, magnesium powder, and n-butyl lithium. The production process is complex and there may still be chlorine contamination. At the same time, due to the high cost of raw materials used in the production of this catalyst, the cost of the catalyst is relatively high. Therefore, it is an urgent need to provide an efficient, chlorine-free, and low-cost catalyst for the synthesis of diisopropylaminosilane.

The information disclosed in the background section is only intended for the enhancement of the overall understanding of the present invention, and should not be regarded as acknowledging or implying in any form that the information constitutes prior art that is already known to those skilled in the art.

### SUMMARY OF THE INVENTION

The main purpose of the present invention is to provide use of a chlorine-free catalyst in the preparation of diisopropylaminosilane, in order to overcome the shortcomings of the prior art.

To achieve the foregoing purpose, an embodiment of the present invention provides use of a chlorine-free catalyst comprising calcium bis(hexamethyldisilazide) and/or strontium bis(hexamethyldisilazide) in the preparation of diisopropylaminosilane. The diisopropylaminosilane is prepared by a dehydrogenative coupling reaction of monosilane with diisopropylamine catalyzed by a chlorine-free catalyst.

An embodiment of the present invention also provides a method for preparing diisopropylaminosilane comprising subjecting a first mixed reaction system comprising diisopropylamine, monosilane, and a chlorine-free catalyst to a dehydrogenative coupling reaction to produce diisopropylaminosilane; wherein the chlorine-free catalyst is calcium bis(hexamethyldisilazide) and/or strontium bis(hexamethyldisilazide).

Compared with the prior art, the present invention has the following beneficial effects:
(1) In the present invention, a low-cost chlorine-free compound, calcium bis(hexamethyldisilazide) and/or strontium bis(hexamethyldisilazide) is used, as a new catalyst to prepare diisopropylaminosilane, which can effectively catalyze the dehydrogenative coupling reaction of monosilane and diisopropylamine;
(2) In the present invention, the activity of calcium bis(hexamethyldisilazide) in the one-step synthesis of diisopropylaminosilane from monosilane and diisopropylamine is comparable to that of dibutylmagnesium, and the yield of diisopropylaminosilane is 40-65%.

### BRIEF DESCRIPTION OF THE DRAWINGS

In order to more clearly illustrate the technical solutions of the embodiments of the present invention or the prior art, a brief description will be given below of the embodiments or the accompanying drawings that are required to be used in the description of the prior art. It is obvious that the drawings in the description below are only some embodiments described in the present invention, and it would be obvious for a person skilled in the art to obtain other drawings according to these drawings without involving any inventive effort.

FIG. 1 is a mass spectrometry spectrum of diisopropylaminosilane prepared in Example 1 of the present invention; and

FIG. 2 is a proton nuclear magnetic resonance spectrum of diisopropylaminosilane prepared in Example 1 of the present invention.

### DETAILED DESCRIPTION OF THE INVENTION

The following is a detailed description of the specific embodiments of the present invention in conjunction with the accompanying drawings, but it should be understood that the scope of the present invention is not limited by the specific embodiments.

Unless otherwise explicitly stated, throughout the entire specification and claims, the term “include” or its variations such as “includes” or “including” shall be understood to include the stated elements or components, without excluding other elements or components.

In view of the shortcomings of the prior art, the inventors of the present invention, through long-term research and extensive practice, has been able to resovle the problem by using a low-cost chlorine-free compound, calcium bis(hexamethyldisilazide) (Ca(N(Si(CH₃)₃)₂)₂), which can effectively catalyze the dehydrogenative coupling reaction of monosilane and diisopropylamine. This catalyst achieves comparable activity to dibutylmagnesium in a process for the one-step synthesis of diisopropylaminosilane starting from monosilane and diisopropylamine.

The following will provide a clear and complete description of the technical solution in the present invention. Obviously, the described embodiments are a part of the embodiments of the present invention, rather than all the embodiments. Based on the embodiments of the present invention, all other embodiments obtained by a person of ordinary skill in the art without inventive effort fall within the scope of the present invention.

In particular, as an aspect of the present invention, it relates to the use of a chlorine-free catalyst comprising calcium bis(hexamethyldisilazide) and/or strontium bis(hexamethyldisilazide) in the preparation of diisopropylaminosilane. The diisopropylaminosilane is prepared by a dehydrogenative coupling reaction of monosilane with diisopropylamine catalyzed by a chlorine-free catalyst.

In some preferred embodiments, the temperature of the dehydrogenative coupling reaction is 60-140° C.

In some embodiments, the time of the dehydrogenative coupling reaction is 4-8 h.

In some embodiments, the chlorine-free catalyst is calcium bis(hexamethyldisilazide).

The chlorine content of the chlorine-free catalyst of the present invention is very low, and there is almost no chlorine contamination in the preparation of diisopropylaminosilane.

Another aspect of embodiments of the present invention provides a preparation method for diisopropylaminosilane. The method includes the step of subjecting a first mixed reaction system which contains diisopropylamine, monosilane, and a chlorine-free catalyst to a dehydrogenative coupling reaction, so as to produce diisopropylaminosilane. The chlorine-free catalyst includes calcium bis(hexamethyldisilazide) and/or strontium bis(hexamethyldisilazide).

In some preferred embodiments, the dehydrogenative coupling reaction specifically includes: placing diisopropylamine and a chlorine-free catalyst in a closed reaction device, then introducing monosilane into the closed reaction device in a manner of building-up pressure or backpressure and performing the dehydrogenative coupling reaction, while controlling the pressure in the closed reaction device to be 1-15 bar.

Further, the introduction rate of the monosilane is 1-5 L/min.

Specifically, in the practice of the present invention, after adding diisopropylamine and the catalyst, monosilane is all at once introduced to a specified pressure, and the reaction is carried out under a closed condition until the reaction is completed, which is referred to as a held pressure reaction mode.

In the practice of the present invention, after adding diisopropylamine and the catalyst, the relief pressure of a backpressure valve at a vent of a reactor is adjusted to a specified value, then a continuous flow of monosilane is started to be fed into the reactor. When the reactor pressure reaches the adjusted specified value of the backpressure valve, the reactor is relieved by the backpressure valve. In this way, monosilane is continuously introduced into the reactor during the reaction, and the pressure is always maintained at the specified value of the backpressure relief valve, which is called backpressure reaction mode.

In some embodiments, the chlorine-free catalyst is calcium bis(hexamethyldisilazide).

In some preferred embodiments, the temperature of the dehydrogenative coupling reaction is 60-140° C.

In some embodiments, the time of the dehydrogenative coupling reaction is 4-8 h.

In some preferred implementation schemes, the mass ratio of diisopropylamine to the chlorine-free catalyst is 100:1-5.

In some preferred embodiments, the molar ratio of diisopropylamine to monosilane is 0.05-0.2 mol: 0.05-0.2 mol.

In some preferred embodiments, the preparation process for the chlorine-free catalyst comprises reacting a second mixed reaction system comprising potassium bis(trimethylsilyl)amide, calcium iodide and/or strontium iodide, and a solvent to produce the chlorine-free catalyst.

Further, the solvent includes diethyl ether.

In the present invention, the entire preparation process of the chlorine-free catalyst is carried out at room temperature, without heating or cooling, in an anhydrous and oxygen-free environment.

Specifically, the synthesis process of calcium bis(hexamethyldisilazide) comprises the following steps: (1) weighing 2 parts (parts by mass) of potassium bis(trimethylsilyl)amide and adding it to a three-necked flask containing 36 parts of diethyl ether; (2) starting stirring, then adding 1.5 parts of calcium iodide to the three-necked flask, and keeping stirring for 48 hours; and (3) after stirring, separating the solid-liquid mixture, pouring the obtained supernatant into an open container, allowing the supernatant to volatilize naturally, and collecting the obtained solid, calcium bis(hexamethyldisilazide).

Specifically, the synthesis process of strontium bis(hexamethyldisilazide) comprises the following steps: (1) weighing 2 parts (parts by mass) of potassium bis(trimethylsilyl)amide and adding to a three-necked flask containing 36 parts of diethyl ether; (2) starting stirring, then adding 1.7 parts of strontium iodide to the three-necked flask, and keeping stirring for 48 hours; and (3) after stirring, separating the solid-liquid mixture, pouring the obtained supernatant into an open container, allowing the supernatant to volatilize naturally, and collecting the obtained solid, strontium bis(hexamethyldisilazide).

In some preferred embodiments, the moisture content in the diisopropylamine is less than or equal to 300 ppm.

In some more specific embodiments, the preparation process of the diisopropylaminosilane comprises the following steps: (1) using diisopropylamine with a moisture content of no more than 300 ppm as a raw material; (2) controlling the reaction temperature to be from 60° C. to 140° C.; (3) adding diisopropylamine into a closed stainless steel reactor and adding catalyst. The amount of the added catalyst is from 1% to 5% by mass of the diisopropylamine, and the catalyst is calcium bis(hexamethyldisilazide); (4) introducing monosilane into the reactor. The monosilane can be introduced into the reactor in a manner of held pressure or backpressure, and the pressure is controlled between 1 bar and 15 bar; hydrogen is released during the reaction; and the reaction time is between 4 and 8 hours; and (5) discharging from the reactor to give diisopropylaminosilane.

The following is a further detailed explanation of the embodiment of the present invention, combined with several preferred embodiments. The present embodiment is implemented based on the embodiments of the present invention and provides detailed procedural steps and specific operational processes. However, the scope of the present invention is not limited to the following examples.

The experimental materials used in the following embodiments, unless otherwise specified, can be purchased from biochemical reagent companies. The chlorine-free catalyst was home-made by the inventors.

Analysis of chlorine content in dibutyl magnesium solution in the present invention: 1.0 N dibutylmagnesium in hexane solvent from Energy Chemical was degraded with water, and then the aqueous phase was filtered to remove insolubles and analyzed by ion chromatography. The chlorine content was determined to be 4000 ppm.

Analysis of chlorine content in calcium bis(hexamethyldisilazide) in the present invention: calcium bis(hexamethyldisilazide), prepared by methods known in the literature was degraded with water, and then the aqueous phase was filtered to remove insolubles and analyzed by ion chromatography. The chlorine content was determined to be 1.4 ppm.

### Supportive Example 1

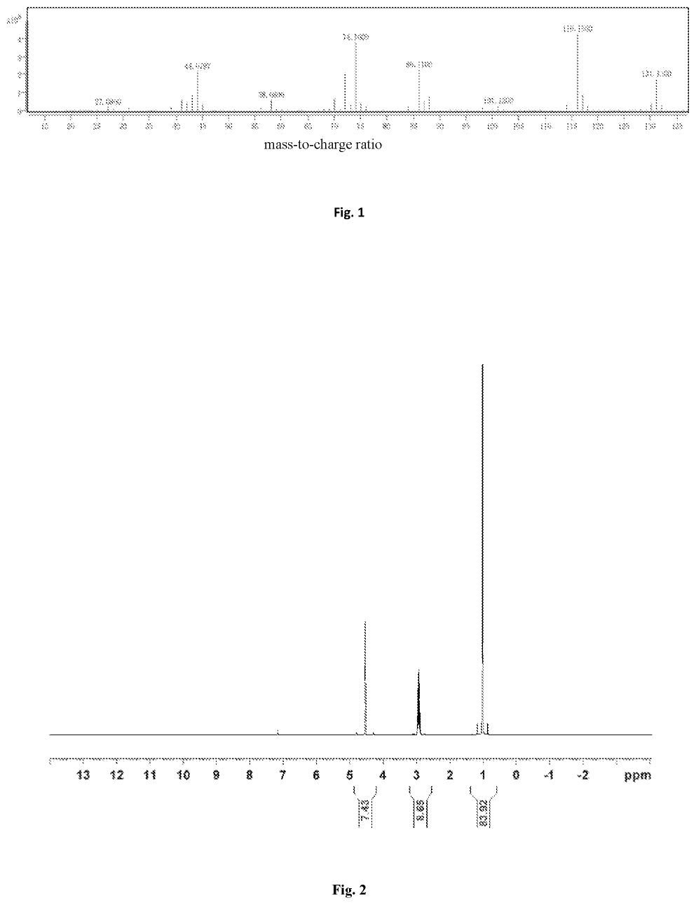

(1) Diisopropylamine with a moisture content of no more than 300 ppm was used as a raw material. (2) 20 ml of diisopropylamine was added into a 250-ml closed stainless steel reactor at room temperature in an anhydrous and oxygen-free environment, and the catalyst was added too. The added amount of the catalyst calcium bis(hexamethyldisilazide) was 3.5% by mass of diisopropylamine. (3) The reactor was heated to 100° C., and the stirring speed of the reactor was 200 rpm. (4) Monosilane was introduced into the reactor at a rate of 5 L/min. After introducing the monosilane, the pressure of the reactor was 8 bar. The reaction lasted for 4 h. (5) After completion of the reaction, the reactor temperature was allowed to drop to room temperature, and the material was discharged to give diisopropylaminosilane, in 55% yield, which is comparable to that when dibutylmagnesium catalyst was used in the prior art. The mass spectrometry spectrum of diisopropylaminosilane prepared in this example is shown in FIG. 1, and the proton nuclear magnetic resonance spectrum is shown in FIG. 2.

### Supportive Example 2

(1) Diisopropylamine with a moisture content of no more than 300 ppm was used as a raw material. (2) 20 ml of diisopropylamine was added into a 250 ml closed stainless steel reactor at room temperature in an anhydrous and oxygen-free environment, and the catalyst was added too. The added amount of the catalyst calcium bis(hexamethyldisilazide) was 3.5% by mass of diisopropylamine. (3) The reactor was heated to 60° C., and the stirring speed of the reactor was 200 rpm. (4) Monosilane was introduced into the reactor at a rate of 5 L/min. After introducing the monosilane, the pressure of the reactor was 12 bar. The reaction lasted for 8 h. (5) After completion of the reaction, the reactor temperature was allowed to drop to room temperature, and the material was discharged to give diisopropylaminosilane, in 42% yield, comparable to that when dibutylmagnesium catalyst was used in the prior art.

### Supportive Example 3

Diisopropylamine with a moisture content of no more than 300 ppm was used as a raw material. 20 ml of diisopropylamine was added into a 250 ml closed stainless steel reactor, at room temperature in an anhydrous and oxygen-free environment. The added amount of the catalyst calcium bis(hexamethyldisilazide) was 3.5% by mass of diisopropylamine. The reactor was heated to 140° C., and the stirring speed of the reactor was 200 rpm. Monosilane was introduced into the reactor at a rate of 5 L/min. After introducing the monosilane, the pressure of the reactor was 8 bar. The reaction lasted for 4 h. After completion of the reaction, the reactor temperature was allowed to drop to room temperature, and the material was discharged to give diisopropylaminosilane, in 62% yield, comparable to that when dibutylmagnesium catalyst was used in the prior art.

### Supportive Example 4

Diisopropylamine with a moisture content of no more than 300 ppm was used as a raw material. 3 L of diisopropylamine was added into a 5 L stainless steel reactor at room temperature in an anhydrous and oxygen-free environment. The added amount of the catalyst calcium bis(hexamethyldisilazide) was 5% by mass of diisopropylamine. Then, The reactor was heated to 120° C., and the stirring speed of the reactor was 200 rpm. The pressure of the backpressure regulating valve at the gas phase vent of the reactor was set at 8 bar. Then, monosilane was introduced into the reactor at a rate of 1 L/min. During the introduction of the monosilane, the pressure of the reactor was held at 8 bar. The reaction lasted for 4 h. After completion of the reaction, the reactor temperature was allowed to drop to room temperature, and the material was discharged to give diisopropylaminosilane, in 57% yield, comparable to that when dibutylmagnesium catalyst was used in the prior art.

In addition, the present inventors have conducted experiments with other materials, process operations, and process conditions described in this specification with reference to the foregoing examples, and have achieved desirable results.

It should be understood that the technical solutions of the present invention are not limited to the specific examples described above and that technical variations according to the technical solutions of the present invention fall within the scope of the present invention without departing from the principles of the invention and the scope of the claims.

The foregoing descriptions of specific exemplary embodiments of the present invention have been presented for purposes of illustration and example. It is not intended to limit the invention to the exact form disclosed, and obviously, many modifications and variations are possible in light of the above-mentioned teaching. The purpose of selecting and describing exemplary embodiments is to explain the specific principles and practical applications of the present invention so that those skilled in the art can implement and utilize various exemplary embodiments of the present invention, as well as various choices and changes. The scope of the present invention is intended to be limited by the claims and the equivalents.

What is claimed is:

1. Use of a chlorine-free catalyst in the preparation of diisopropylaminosilane, wherein the chlorine-free catalyst comprises calcium bis(hexamethyldisilazide) and/or strontium bis(hexamethyldisilazide), and the diisopropylaminosilane is prepared by a dehydrogenative coupling reaction of monosilane with diisopropylamine catalyzed by a chlorine-free catalyst.

2. The use of claim 1, wherein the temperature of the dehydrogenative coupling reaction is 60-140° C.

3. The use of claim 1, wherein the time of the dehydrogenative coupling reaction is 4-8 h.

4. The use of claim 1, wherein the chlorine-free catalyst is calcium bis(hexamethyldisilazide).

5. A preparation method for diisopropylaminosilane, comprising:
subjecting a first mixed reaction system comprising diisopropylamine, monosilane, and a chlorine-free catalyst to a dehydrogenative coupling reaction to produce diisopropylaminosilane;
wherein the chlorine-free catalyst comprises calcium bis(hexamethyldisilazide) and/or strontium bis(hexamethyldisilazide).

6. The preparation method of claim 5, wherein the dehydrogenative coupling reaction comprises:
placing diisopropylamine and a chlorine-free catalyst in a closed reaction device;
introducing monosilane into the closed reaction device in a manner of held pressure or backpressure; and
performing the dehydrogenative coupling reaction, while controlling the pressure in the closed reaction device to be 1-15 bar.

7. The preparation method of claim 5, characterized in that, the chlorine-free catalyst is calcium bis(hexamethyldisilazide).

8. The preparation method of claim 5, wherein the temperature of the dehydrogenative coupling reaction is 60-140° C.

9. The preparation method of claim 5, wherein the time of the dehydrogenative coupling reaction is 4-8 h.

10. The preparation method of claim 5, wherein the mass ratio of diisopropylamine to the chlorine-free catalyst is 100:1-5.

11. The preparation method of claim 5, wherein the molar ratio of diisopropylamine to monosilane is 0.05-0.2:0.05-0.2.

12. The preparation method of claim 5, wherein the preparation process of the chlorine-free catalyst comprises: reacting a second mixed reaction system comprising potassium bis(trimethylsilyl)amide, calcium iodide, and/or strontium iodide, and a solvent to produce the chlorine-free catalyst; the solvent comprising diethyl ether.

13. The preparation method of claim 5, wherein the moisture content in diisopropylamine is less than or equal to 300 ppm.
